(19) United States
(12) Patent Application Publication
(10) Pub. No.: US 2025/0035977 A1
(43) Pub. Date: Jan. 30, 2025

(54) LIGHT GUIDE PLATE, LIGHT GUIDE MEMBER AND BACKLIGHT UNIT INCLUDING THE SAME

(71) Applicant: MEMSLUX, Daejeon (KR)

(72) Inventors: Ho Won LEE, Daejeon (KR); Jaeho SIM, Daejeon (KR)

(73) Assignee: MEMSLUX, Daejeon (KR)

(21) Appl. No.: 18/785,615

(22) Filed: Jul. 26, 2024

(30) Foreign Application Priority Data
Jul. 28, 2023 (KR) 10-2023-0099226
Aug. 31, 2023 (KR) 10-2023-0115667

(51) Int. Cl. G02F 1/1335; G02F 1/13357

(52) U.S. Cl. CPC G02F 1/133524; G02F 1/133504; G02F 1/133553; G02F 1/133607; G02F 1/133615

(57) ABSTRACT

A light guide plate allows light received and guided through one side surface to be reflected and/or refracted by a bottom surface and to be emitted through a top surface. Here, the bottom surface includes a plurality of engraved light emission patterns, the bottom surface includes a plurality of outer inclined surfaces that define the light emission patterns, the plurality of outer inclined surfaces includes a first outer inclined surface, a second outer inclined surface, a third outer inclined surface, and a fourth outer inclined surface. Also, the first and third outer inclined surfaces each protrude in an outward direction and are disposed to face each other, one of the first and third outer inclined surfaces is disposed to face the one side surface, and the second and fourth outer inclined surfaces are disposed to face each other and disposed between the first and third outer inclined surfaces.

### CROSS-REFERENCE TO RELATED APPLICATIONS

This U.S. Non-Provisional Patent Application claims priority under 35 USC § 119 of Korean Patent Application No. 10-2023-0099226, filed on Jul. 28, 2023, and Korean Patent Application No. 10-2023-0115667, filed on Aug. 31, 2023, the entire contents of all of which are hereby incorporated by reference herein, for all purposes.

### BACKGROUND

The present disclosure relates to a light guide plate, a light guide member, and a backlight unit including the same, and more particularly, to a light guide plate, a light guide member, and a backlight unit including the same, which are applicable to a front light source or an interior lighting for enhancing night visibility of a reflective display such as a backlight unit of a liquid crystal display, a front light unit of a reflective display, electronic paper, and a mirasol display.

FIG. 1 is a perspective view illustrating a typical flat backlight unit.

Referring to FIG. 1, the typical flat backlight unit includes a reflector, a light guide plate LGP, a diffuser sheet, a prism sheet H, a prism sheet V, a liquid crystal display LCD, and a light source CCFL or LED.

The light guide plate serves to emit light incident into a side surface upward from a flat surface. A three-dimensional structure or a two-dimensional pattern is formed on a surface of the light guide plate.

Since the three-dimensional or two-dimensional diffuser reflection patterns of the light guide plate emit light to both front and rear surfaces of the light guide plate, the reflector reflects light to the rear surface.

The diffuser sheet removes a dot caused by the patterns on the light guide plate.

The prism sheet compensates a traveling direction of light emitted in a state of being inclined to a vertical direction, so that the light is emitted in the vertical direction. To this end, two prism sheets are required for each of the horizontal and vertical directions.

Although not shown in FIG. 1, a protection sheet protects the flat backlight unit.

Since each of the diffuser sheet and the prism sheet of the typical backlight unit in FIG. 1 has a multi-layer sheet structure (i.e., a composite sheet), a thickness of the backlight unit increases. Also, this causes a limitation of increase in manufacturing cost and degradation in optical efficiency.

### SUMMARY

The present disclosure provides a light guide plate, a light guide member, and a backlight unit including the same, which internalize functions of a diffuser sheet and a prism sheet of a typical flat backlight unit to eliminate dependence on an optical sheet.

An embodiment of the present invention provides a light guide plate that allows light received and guided through one side surface to be reflected and/or refracted by a bottom surface and to be emitted through a top surface. Here, the bottom surface includes a plurality of engraved light emission patterns, the bottom surface includes a plurality of outer inclined surfaces that define the light emission patterns, the plurality of outer inclined surfaces include a first outer inclined surface, a second outer inclined surface, a third outer inclined surface, and a fourth outer inclined surface. Also, the first and third outer inclined surfaces protrude in an outward direction and are disposed to face each other, one of the first and third outer inclined surfaces is disposed to face the one side surface, and the second and fourth outer inclined surfaces are disposed to face each other and disposed between the first and third outer inclined surfaces.

In another embodiment of the present invention, a light guide member includes: a light guide plate configured to receive light through one side surface and emit light through a top surface; and a light emission pattern layer disposed on a bottom surface of the light guide plate. Here, the light emission pattern layer includes a bottom surface having a plurality of engraved light emission patterns, the bottom surface of the light emission pattern layer includes a plurality of outer inclined surfaces that define the light emission patterns, the plurality of outer inclined surfaces include a first outer inclined surface, a second outer inclined surface, a third outer inclined surface, and a fourth outer inclined surface, the first and third outer inclined surfaces protrude in an outward direction to face each other, and one of the first and third outer inclined surfaces faces toward a surface parallel to the one side surface, and the second and fourth outer inclined surfaces are disposed to face each other and disposed between the first and third outer inclined surfaces.

### BRIEF DESCRIPTION OF THE FIGURES

The accompanying drawings are included to provide a further understanding of the inventive concept and are incorporated in and constitute a part of this specification. The drawings illustrate exemplary embodiments of the inventive concept and, together with the description, serve to explain principles of the inventive concept. In the drawings:

FIG. 1 is a perspective view illustrating a typical flat backlight unit;

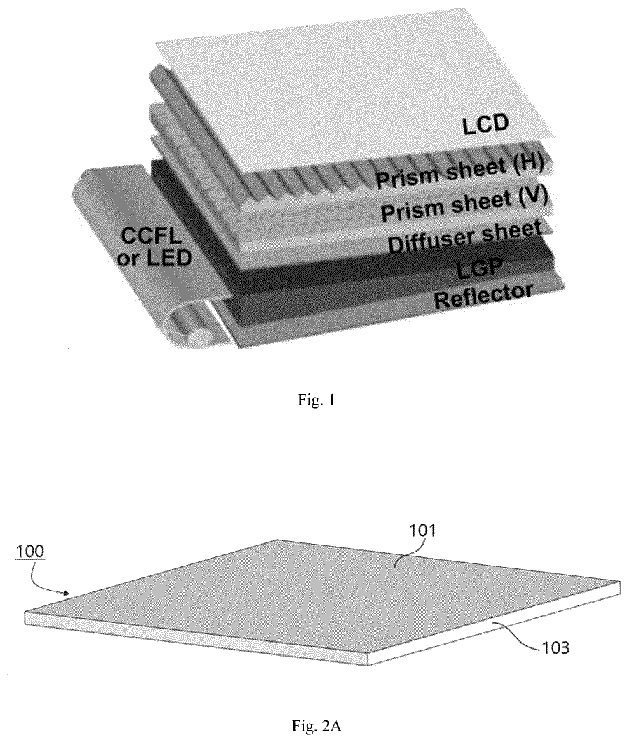

FIG. 2A is a perspective view illustrating a light guide plate 100 according to another embodiment of the present invention when viewed from above, and FIG. 2B is a perspective view illustrating the light guide plate 100 of FIG. 2A when viewed from below;

FIGS. 3A to 3C are cross-sectional views for explaining a light emitting structure of the light guide plate 100 in FIGS. 2A and 2B;

FIG. 4 is a view illustrating a light distribution of the light guide plate in FIG. 3A;

FIG. 5A is a plan view illustrating a light emission pattern 150-1 according to a first embodiment of the light emission pattern 150 in FIGS. 2A and 2B, and FIG. 5B is a cross-sectional view taken along line A-A′ of FIG. 5A;

FIG. 6A is a plan view illustrating a light emission pattern 150-2 according to a second embodiment of the light emission pattern 150 in FIGS. 2A and 2B, and FIG. 6B is a cross-sectional view taken along line B-B′ of FIG. 6A;

A left drawing of FIG. 7 shows a light distribution of the light guide plate having the light emission pattern 150-1 in FIGS. 5A and 5B, and a right drawing of FIG. 7 shows a light distribution of the light guide plate having the light emission pattern 150-2 in FIGS. 6A and 6B;

FIG. 8 is a photograph for explaining a searchlight phenomenon;

FIGS. 9A to 9C are views for explaining a relationship between a curvature R2 of a first or third outer inclined surface 151a′ and 151c′ of the light emission pattern 150-2 in FIGS. 6A and 6B and the searchlight phenomenon;

FIG. 10 is a view for explaining a light guide plate according to another embodiment of the present invention;

FIG. 11 is a photograph for explaining a divergence angle of light in the light guide plate;

FIG. 12 is an enlarged view illustrating a portion of a bottom surface 102 of another light guide plate having the plurality of light emission patterns 150-2 in FIGS. 6A and 6B;

FIG. 13 is a substantial photograph showing light emitting surfaces of the light guide plates in FIGS. 10 and 12;

FIG. 14 is a SEM image showing a portion of the bottom surface of the light guide plate having the plurality of light emission patterns 150-2 in FIG. 10;

FIGS. 15A and 15B are views for explaining a light guide member 1500 according to another embodiment of the present invention;

FIG. 16 is a perspective view of another light emission pattern 150-4 that is applicable to FIGS. 2A and 2B and FIGS. 15A and 15B;

FIG. 17 is a plan view illustrating a light emission pattern 150-4 in FIG. 16; and

FIGS. 18A and 18B are cross-sectional views taken along lines A-A and B-B of the light emission pattern 150-4 of the light guide plate or the light emission pattern layer in FIG. 17.

### DETAILED DESCRIPTION

Hereinafter, preferred embodiments of the present invention will be described in detail with reference to the accompanying drawings. It will be understood that the same reference numerals designate the same components throughout the drawings. For reference, detailed descriptions related to well-known functions or configurations will be ruled out in order not to unnecessarily obscure subject matters of the present invention.

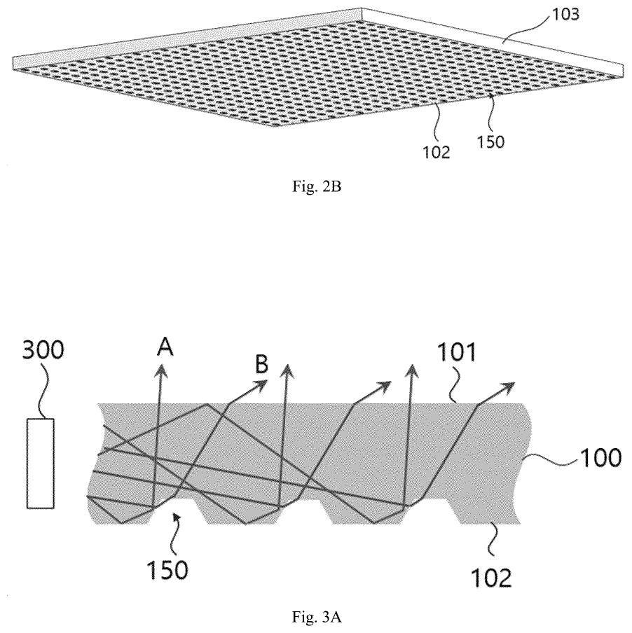

FIG. 2A is a perspective view illustrating a light guide plate 100 according to another embodiment of the present invention when viewed from above, and FIG. 2B is a perspective view illustrating the light guide plate 100 of FIG. 2A when viewed from below.

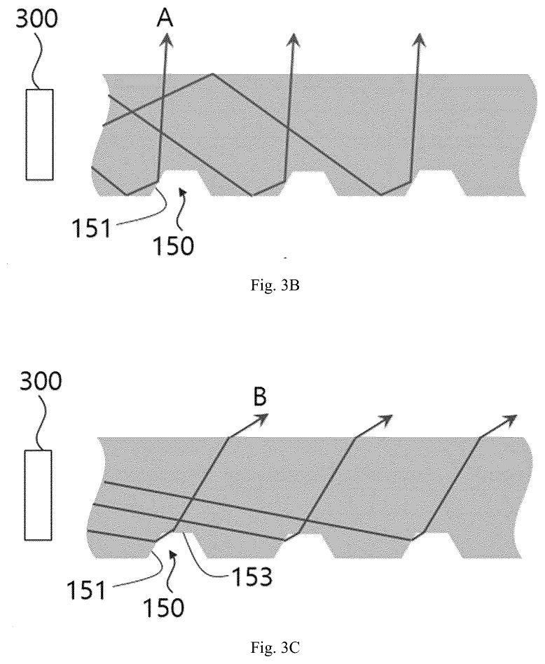

FIGS. 3A to 3C are cross-sectional views for explaining a light emitting structure of the light guide plate 100 illustrated in FIGS. 2A and 2B.

Referring to FIGS. 2A, 2B, and 3A to 3C, a backlight unit according to an embodiment of the present invention includes a light guide plate 100 and a light source 300.

The light guide plate 100 receives light from the light source 300 through one side surface 103 and emits light through a top surface 101.

A plurality of light emission patterns 150 are arranged on a bottom surface 102 of the light guide plate 100. Each of the light emission patterns 150 has an engraved pattern. The engraved pattern may have a triangular or trapezoidal cross-sectional shape. Here, at least a portion of the trapezoidal shape may be curved. A planar shape of the engraved pattern may be a circle, a polygon, or an irregular closed curve, and a circle, a polygon, or an irregular closed curve structure may be inserted to a center thereof. An angle distribution arrangement of the engraved pattern may be applied at an optimized coordinate of the designed engraved pattern, and the angle distribution arrangement may have a range from −45° to 45°.

Referring to FIG. 3A, emission light emitted from the top surface 101 of the light guide plate 100 includes first emission light A emitted through a vertical light emission path and second emission light B emitted through a high-angle light emission path.

FIG. 3B illustrates only the first emission light A emitted through the vertical light emission path of FIG. 3A, and FIG. 3C illustrates only the second emission light B through the high-angle light emission path of FIG. 3A.

Referring to FIG. 3B, the first emission light A is light that is totally reflected by the top surface 101 and the bottom surface 102 of the light guide plate 100 to travel therein, reflected by an inclined surface 151 of each of the light emission patterns 150, and then emitted to the outside through the top surface 101 of the light guide plate 100. The first emission light A may have a light emission path that is adjusted according to an angle of the inclined surface 151 of each of the light emission patterns 150 formed on the light guide plate 100.

Referring to FIG. 3C, the second emission light B is light that is incident through one side surface of the light guide plate 100, refracted at each of the inclined surface 151, and an inner top surface 153, and the top surface 102 of the light guide plate 100, and then emitted to the outside instead of being totally reflected by the inclined surface 151 of each of the light emission patterns 150. The second light emission light B may have a light emission element that is adjusted according to a shape of the inner top surface 153 of each of the light emission patterns 150 formed on the light guide plate 100.

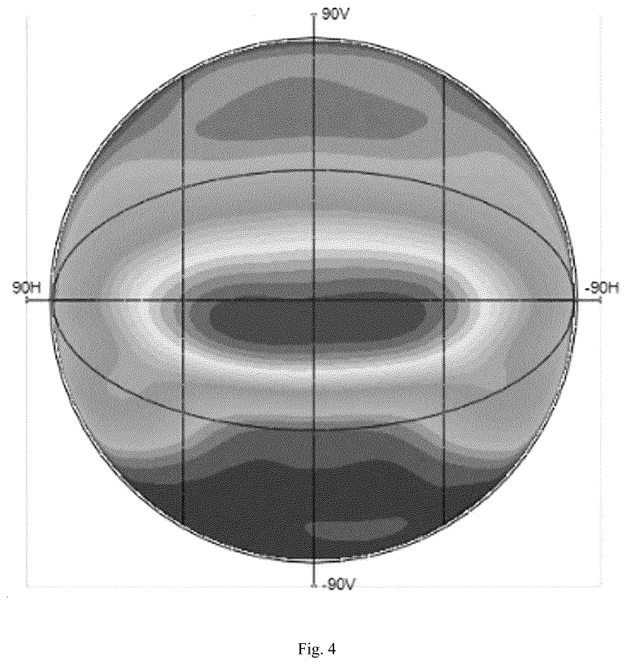

As illustrated in FIGS. 3A to 3C, the inventor of the present invention has checked that a light guide plate having an intended light distribution as in FIG. 4 may be designed by adjusting an angle of the inclined surface 151 of each of the light emission patterns 150 and/or a shape of the inner top surface 153 of each of the light emission patterns 150.

Referring to FIG. 4, the light distribution of the light guide plate according to an embodiment of the present invention has a characteristic in which the light distribution in a horizontal direction (from 90H to −90H) is more dominant than that in a vertical direction (from 90V to −90V). The light guide plate having the above-described light distribution has an advantage of being applied to not only a vehicle display product but also a display product for special purposes. The vehicle display product may have a screen that is viewable from both driver and passenger seats. Since there is a disadvantage in that the screen may be reflected on a window when the light distribution in the vertical direction (from 90V to −90V) is wide, it is required that the light distribution in the horizontal direction is wide, and the light distribution in the vertical direction is relatively narrow.

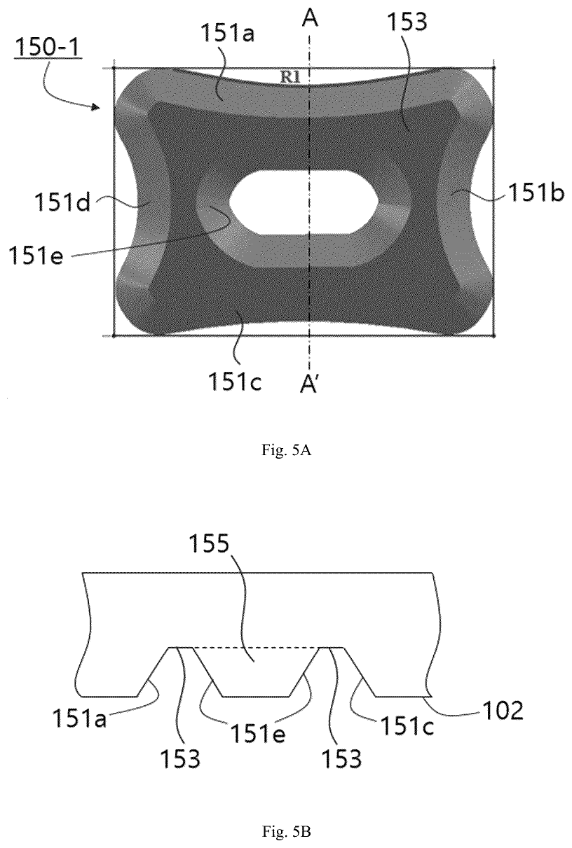

FIG. 5A is a plan view illustrating a light emission pattern 150-1 according to a first embodiment of the light emission pattern 150 in FIGS. 2A and 2B, and FIG. 5B is a cross-sectional view taken along line A-A′ of FIG. 5A.

Referring to FIGS. 5A and 5B, the light emission pattern 150-1 according to the first embodiment may be a pattern defined by a plurality of inclined surfaces 151a, 151b, 151c, 151d, and 151e and an inner top surface 153 of a light guide plate.

The plurality of inclined surfaces 151a, 151b, 151c, 151d, and 151e include a first outer inclined surface 151a, a second outer inclined surface 151b, a third outer inclined surface 151c, and a fourth outer inclined surface 151d.

The first outer inclined surface 151a is disposed to face the third outer inclined surface 151c.

One of the first outer inclined surface 151a and the third outer inclined surface 151c is disposed to face toward a light source.

One of the first outer inclined surface 151a and the third outer inclined surface 151c may be a curved surface recessed in an inward direction of the light emission pattern 150-1. One of the first outer inclined surface 151a and the third outer inclined surface 151c has a predetermined curvature R1.

As illustrated in FIG. 5B, each of the first outer inclined surface 151a and the third outer inclined surface 151c form an obtuse angle with a bottom surface 102 of the light guide plate.

The second outer inclined surface 151b is disposed to face the fourth outer inclined surface 151d.

The second outer inclined surface 151b and the fourth outer inclined surface 151d are disposed between the first outer inclined surface 151a and the third outer inclined surface 151c.

One of the second outer inclined surface 151a and the fourth outer inclined surface 151d may be a curved surface recessed in an inward direction of the light emission pattern 150-1. When one of the second outer inclined surface 151b and the fourth outer inclined surface 151d is the recessed curved surface, there is an advantage of relatively further reducing an entire area of the inner top surface 153.

Although not shown in the drawing, one of the second outer inclined surface 151b and the fourth outer inclined surface 151d may be a curved surface protruding in an outward direction of the light emission pattern 150-1.

Each of the second outer inclined surface 151b and the fourth outer inclined surface 151d may form an obtuse angle with the bottom surface 102 of the light guide plate as with the first outer inclined surface 151a and the third outer inclined surface 151c in FIG. 5B.

The first to fourth outer inclined surfaces 151a, 151b, 151c, and 151d may be connected to each other to define a side shape of the light emission pattern 150-1.

The plurality of inclined surfaces 151a, 151b, 151c, 151d, and 151e may further include an inner inclined surface 151e. The inner inclined surface 151e may be a side surface of a protrusion 155 protruding upward from the inner top surface 153.

The protrusion 155 may have a frustum shape. For example, the protrusion 155 may be a circular frustum, a polygonal frustum, or an elliptical frustum. The protrusion 155 may have a trapezoidal cross-sectional shape as illustrated in FIG. 5B.

The inner top surface 153 may be a flat surface parallel to the top surface or bottom surface 102 of the light guide plate. The protrusion 155 may be disposed at a central portion of the inner top surface 153. As an area of the inner top surface 153 decreases, the high-angle light emission component in FIG. 3C may decrease. An area of the inner top surface 153 may decrease by forming the protrusion 155.

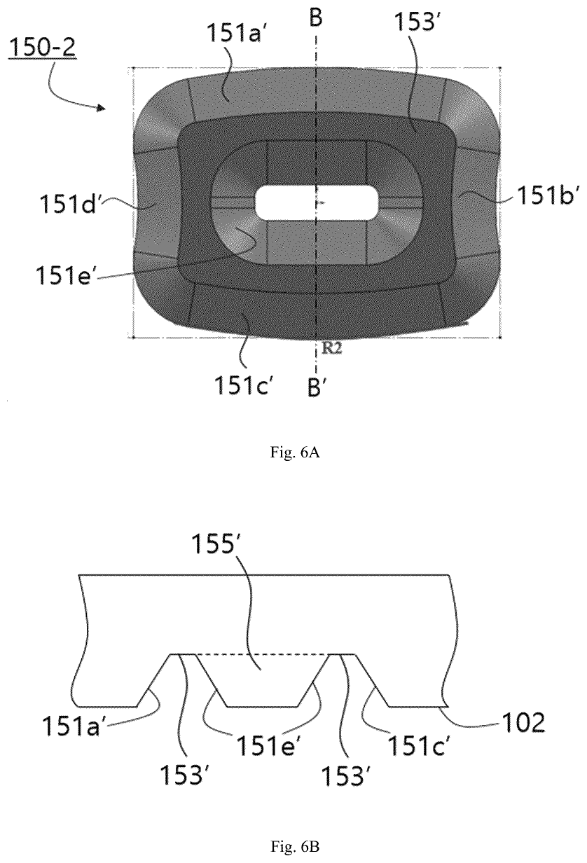

FIG. 6A is a plan view illustrating a light emission pattern 150-2 according to a second embodiment of the light emission pattern 150 in FIGS. 2A and 2B, and FIG. 6B is a cross-sectional view taken along line B-B′ of FIG. 6A.

Referring to FIGS. 6A and 6B, the light emission pattern 150-2 according to the second embodiment may be an engraved pattern defined by a plurality of inclined surfaces 151a′, 151b′, 151c′, 151d′, and 151e′ and an inner top surface 153′ of a light guide plate.

The plurality of inclined surfaces 151a′, 151b′, 151c′, 151d′, and 151e′ include a first outer inclined surface 151a′, a second outer inclined surface 151b′, a third outer inclined surface 151c′, and a fourth outer inclined surface 151d′.

The first outer inclined surface 151a′ is disposed to face the third outer inclined surface 151c′.

One of the first outer inclined surface 151a′ and the third outer inclined surface 151c′ is disposed to face toward a light source.

One of the first outer inclined surface 151a′ and the third outer inclined surface 151c′ may be a curved surface protruding in an outward direction of the light emission pattern 150-2. A light emission angle distribution in the horizontal direction of the light emitted from the top surface of the light guide plate may be controlled according to a shape of the protruding curved surface.

One of the first outer inclined surface 151a′ and the third outer inclined surface 151c′ has a predetermined curvature R2.

A central angle of a fan using, as an arc, a line in contact with the bottom surface 102 in one of the first outer inclined surface 151a′ or the third outer inclined surface 151c′ may be an acute angle or an obtuse angle.

As illustrated in FIG. 6B, each of the first outer inclined surface 151a′ and the third outer inclined surface 151c′ may form an obtuse angle with the bottom surface 102 of the light guide plate based on both ends in each of the first outer inclined surface 151a′ and the third outer inclined surface 151c′.

A vertical light emission angle may be controlled by adjusting the angle between the outer inclined surface to which light is incident among the first outer inclined surface 151a′ and the third outer inclined surface 151c′ and the bottom surface 102. Typically, a separate prism sheet is provided on the light guide plate to control the vertical light emission angle. However, according to an embodiment of the present invention, since the vertical light emission angle may be adjusted by adjusting an angle of the outer inclined surface to which light is incident, a prism sheet is not required.

The second outer inclined surface 151b′ is disposed to face the fourth outer inclined surface 151d′.

The second outer inclined surface 151b′ and the fourth outer inclined surface 151d′ are disposed between the first outer inclined surface 151a′ and the third outer inclined surface 151c′.

One of the second outer inclined surface 151b′ and the fourth outer inclined surface 151d′ may be a curved surface recessed in an inward direction of one of the light emission patterns 150-2. When one of the second outer inclined surface 151b′ and the fourth outer inclined surface 151d′ is the recessed curved surface, there is an advantage of relatively further reducing an entire area of the inner top surface 153′.

Although not shown in the drawing, one of the second outer inclined surface 151b′ and the fourth outer inclined surface 151d′ may be a curved surface protruding in an outward direction of one of the light emission patterns 150-2.

Each of the second outer inclined surface 151b′ and the fourth outer inclined surface 151d′ may form an obtuse angle with the bottom surface 102 of the light guide plate as with the first outer inclined surface 151a′ and the third outer inclined surface 151c′ in FIG. 6B.

The first to fourth outer inclined surfaces 151a′, 151b′, 151c′, and 151d′ may be connected to each other to define a side shape of the light emission pattern 150-2.

The plurality of inclined surfaces 151a′, 151b′, 151c′, 151d′, and 151e′ may further include an inner inclined surface 151e′. The inner inclined surface 151e′ may be a side surface of a protrusion 155′ protruding upward from the inner top surface 153′.

The protrusion 155′ may have a frustum shape having a width that gradually decreases in a direction from the top surface to the bottom surface of the light guide plate. For example, the protrusion 155′ may be a circular frustum, a polygonal frustum, or an elliptical frustum. The protrusion 155′ may have a trapezoidal cross-sectional shape as illustrated in FIG. 6B.

The inner top surface 153 may be a flat surface parallel to the top surface or bottom surface 102 of the light guide plate. The protrusion 155′ may be disposed at a central portion of the inner top surface 153′. As an area of the inner top surface 153′ decreases, the high-angle light emission component in FIG. 3C may decrease. An area of the inner top surface 153′ may decrease by forming the protrusion 155′. Also, a recycle function of emitting a portion of inner refracted light in a vertical direction may be performed by forming the protrusion 155′.

A left drawing of FIG. 7 shows a light distribution of the light guide plate having the light emission pattern 150-1 in FIGS. 5A and 5B, and a right drawing of FIG. 7 shows a light distribution of the light guide plate having the light emission pattern 150-2 in FIGS. 6A and 6B.

The two light distributions in FIG. 7 are based on an assumption in which the curvature R1 of the first or third outer inclined surface 151a or 151c in FIG. 5A is equal to the curvature R2 of the first or third outer inclined surface 151a′ or 151c′ in FIG. 6A.

Referring to the two light distributions in FIG. 7, the light guide plate having the light emission pattern 150-1 in FIGS. 5A and 5B exhibits an angular distribution characteristic similar to that of the light guide plate having the light emission pattern 150-2 in FIGS. 6A and 6B. This similarity is caused by the feature in which R1 is equal to R2. The light guide plates having the two light distributions have an advantage of being applied to a display product having a special viewing angle for vehicles. Also, the light guide plates have an advantage of being applied to a display device or a functional display device, which does not require a display window or sheet.

Referring to the two light distributions in FIG. 7, the light distribution in the horizontal direction may be adjusted by adjusting the curvature R1 or R2 of the first or third outer inclined surface 151a, 151a′, 151c, and 151c′ of the light emission pattern 150-1 in FIGS. 5A and 5B or the light emission pattern in FIGS. 6A and 6B, and the light distribution in the vertical direction may be adjusted by adjusting an angle between the first or third outer inclined surface 151a, 151a′, 151c, and 151c′ and the bottom surface 102 of the light guide plate.

In the two light guide plates, when surface areas of the inclined surfaces 151a, 151b, 151c, 151d, and 151e of the light emission pattern 150-1 in FIGS. 5A and 5B are the same as those of the inclined surfaces 151a′, 151b′, 151c′, 151d′, and 151e′ of the light emission pattern 150-2 in FIGS. 6A and 6B, there is an advantage in that the light emission pattern 150-2 in FIGS. 6A and 6B is relatively less in size than the light emission pattern 150-1 in FIGS. 5A and 5B. That is, a footprint occupied by the light emission pattern 150-2 in FIGS. 6A and 6B is relatively less than that occupied by the light emission pattern 150-1 in FIGS. 5A and 5B.

Also, each of the inner top surfaces 153 and 153′ of the light emission patterns 150-1 and 150-2 in FIGS. 6A and 6B has an area less than that of the inner top upper surface 153′ of the light emission pattern 150-2. That is, an amount of high-angle light emission components of the light emission pattern 150-2 in FIGS. 6A and 6B may be reduced more relatively to that of the high-angle light emission components of the light emission pattern 150-1 in FIGS. 5A and 5B. Also, as a size of each of the two light emission patterns decreases, a disadvantage in which a light emission pattern having a relatively large size is recognized or felt as a dot may be compensated.

Also, the light guide plate having the light emission pattern 150-2 in FIGS. 6A and 6B is more effective in relieving the searchlight phenomenon than the light guide plate having the light emission pattern 150-1 in FIGS. 5A and 5B.

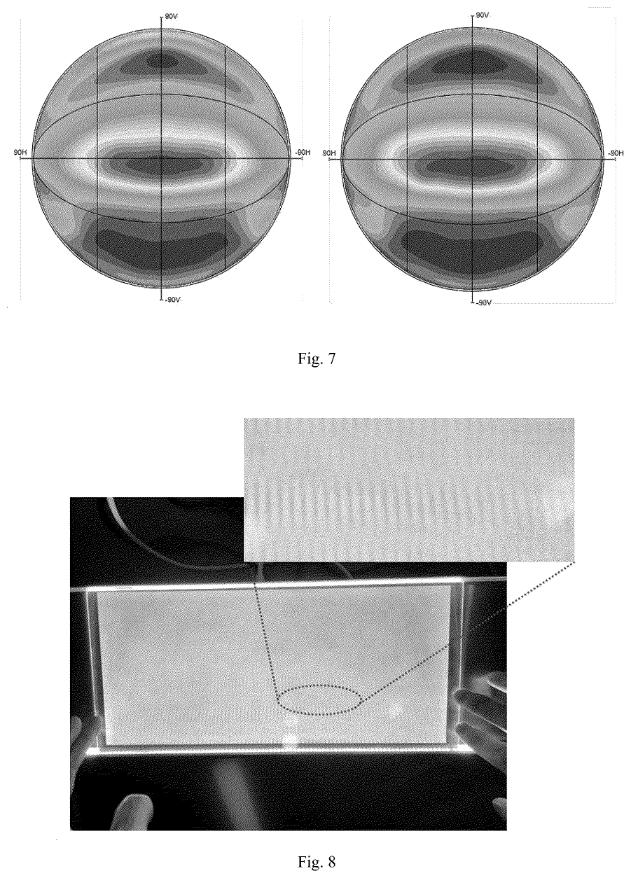

Here, as illustrated in FIG. 8, the searchlight phenomenon represents that in which, when light is incident from each light source to the light guide plate, and each light component at a specific angle is reflected by the inclined surface of the light emission pattern of the light emission pattern of the light guide plate and emitted through the top surface, the light component is reinforced or amplified so that a visually bright portion and a visually dark portion are continuously seen.

Typically, a separate diffuser sheet is provided on the light guide plate to relieve the searchlight phenomenon.

However, the light guide plates according to embodiments of the present invention, which will be described below, may relieve or remove the searchlight phenomenon instead of using the separate diffuser sheet. Also, a separate prism sheet may not be used to adjust the light emission angle.

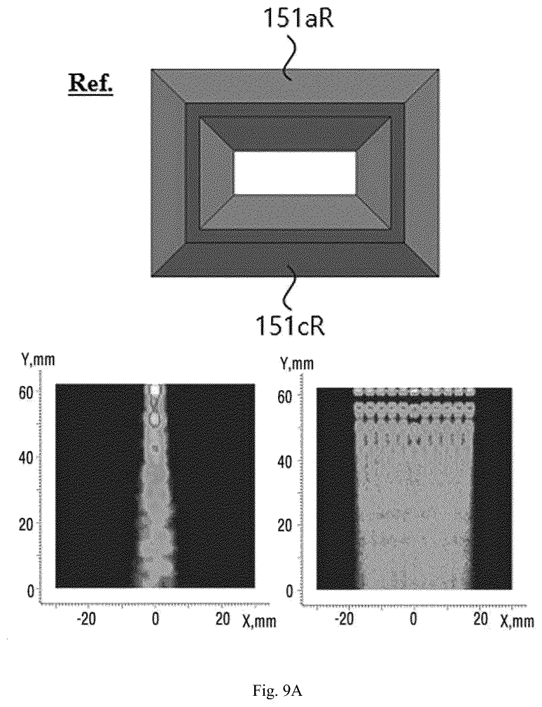

First, relief of the searchlight phenomenon by own structure of the light emission pattern 150-2 will be explained. As the curvature R2 of the first or third outer inclined surface 151a′ and 151c′ of the light emission pattern 150-2 in FIGS. 6A and 6B increases (or as a radius of curvature decreases), the searchlight phenomenon may be relieved. This will be described with reference to FIGS. 9A and 9C.

FIGS. 9A to 9C are views for explaining a relationship between the curvature R2 of the first or third outer inclined surface 151a′ and 151c′ of the light emission pattern 150-2 in FIGS. 6A and 6B and the searchlight phenomenon.

FIG. 9A is a view illustrating a reference light emission pattern Ref., and a first or third outer inclined surface 151aR or 151cR has a curvature of zero. Referring to graphs of light emission surface distributions of a light guide plate having the reference light emission pattern Ref., it may be known that a searchlight phenomenon is prominent.

FIG. 9B is a view illustrating the light emission pattern 150-2 in FIGS. 6A and 6B, and a first or third outer inclined surfaces 151a′ or 151c′ has a predetermined curvature R2. It may be known that the searchlight phenomenon in a light emission surface distribution of the light guide plate having the light emission pattern 150-2 in FIGS. 6A and 6B is relieved when compared with that of FIG. 9A.

FIG. 9C is a view illustrating a light emission pattern 150-3 according to a modified example of the light emission pattern 150-2 in FIGS. 6A and 6B. Here, a first or third outer inclined surface 151a″ or 151c″ has a predetermined curvature R2′. The curvature R2′ is relatively greater than the curvature R2 of the light emission pattern 150-2 in FIGS. 6A and 6B (where, since a radius of curvature is a reciprocal number of the curvature, the radius of curvature of R2′ is less than that of R2). When compared with FIG. 9B, it may be known that the searchlight phenomenon is further relieved in a light emission surface distribution of the light guide plate having the light emission pattern 150-3 according to the modified example.

As illustrated in FIGS. 9A to 9C, it may be known that the searchlight phenomenon is improved as the curvature of the protruding first or third outer inclined surface of the light emission pattern increases (or as a radius of curvature decreases).

Next, a method for relieving or removing the searchlight phenomenon by changing a structural arrangement of a plurality of light emission patterns instead of adjusting the curvature of the light emission pattern 150-2 will be described.

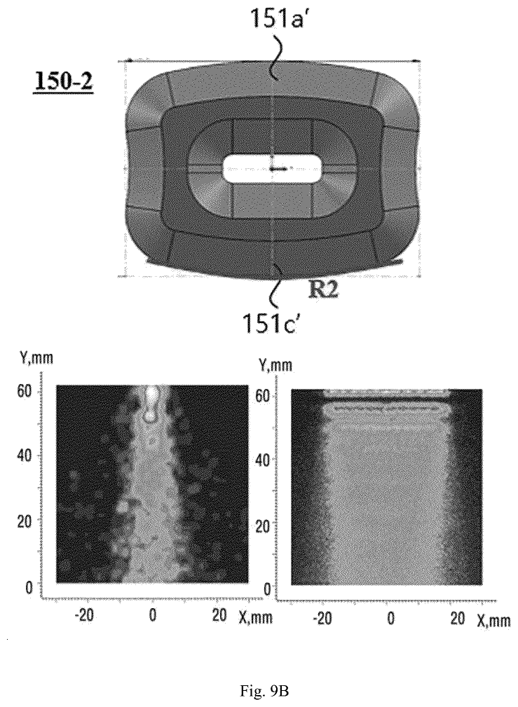

FIG. 10 is an enlarged front view illustrating a portion of the bottom surface 102 of the light guide plate having the plurality of light emission patterns 150-2 in FIGS. 6A and 6B for explaining a light guide plate according to another embodiment of the present invention.

Referring to FIG. 10, the light guide plate according to another embodiment of the present invention includes a plurality of light emission patterns 150-2 formed on the bottom surface 102. The plurality of light emission patterns 150-2 may be arranged randomly on the bottom surface 102.

Each of the light emission patterns 150-2 has a predetermined distortion within an angular range of −θ or more to +θ or less based on a reference axis X.

Here, the reference axis X may be a direction perpendicular to a direction Y from a light source 300 to the light guide plate, a direction parallel to a light emitting surface of the light source 300, or a direction parallel to one side surface of the light guide plate to which light emitted from the light source 300 is incident.

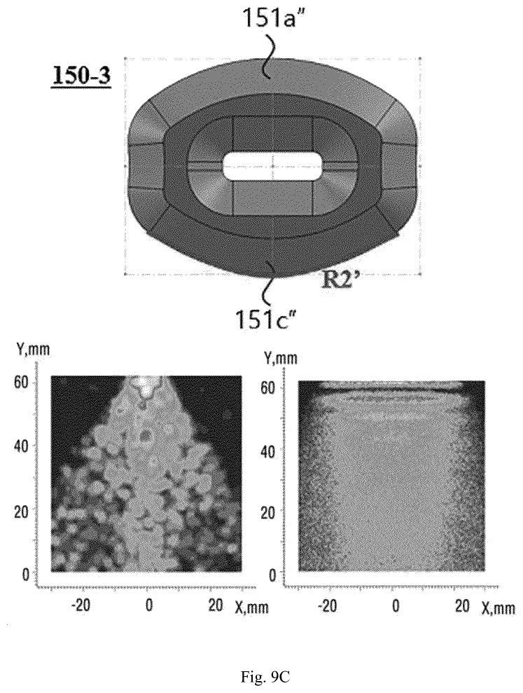

Also, a reference symbol θ may correspond to a divergence angle of the light incident to one side surface of the light guide plate in the light guide plate. Here, as illustrated in FIG. 11, the divergence angle may represent an angle at which most of light components of light incident into the light guide plate and diverged at various angles are concentrated.

As illustrated in FIG. 10, each of the plurality of light emission patterns 150-2 is distorted at a predetermined angle based on the reference axis X. Here, the predetermined angle may be within a range from −θ to +θ, and the reference symbol θ may be a divergence angle of the light incident into one side surface of the light guide plate. For example, the reference symbol θ may be an angle in a range from 15° to 20°.

Among the plurality of light emission patterns 150-2, one light emission pattern P1 has a distortion angle of 0° based on the reference axis X, another light emission pattern P2 has a distortion angle of +θ based on the reference axis X, and another light emission pattern P3 has a distortion angle of −θ based on the reference axis X.

The number of light emission patterns for each distortion angle among the plurality of light emission patterns 150-2 may be uniform. For example, when the reference symbol θ is 15°, the number of light emission patterns distorted at 15°, the number of light emission patterns distorted at 14°, the number of light emission patterns distorted at 1°, the number of light emission patterns distorted at 2°, the number of light emission patterns distorted at −14°, and the number of light emission patterns distorted at −15° may be the same as a predetermined number. Here, the specific angles may be varied according to intention of a designer.

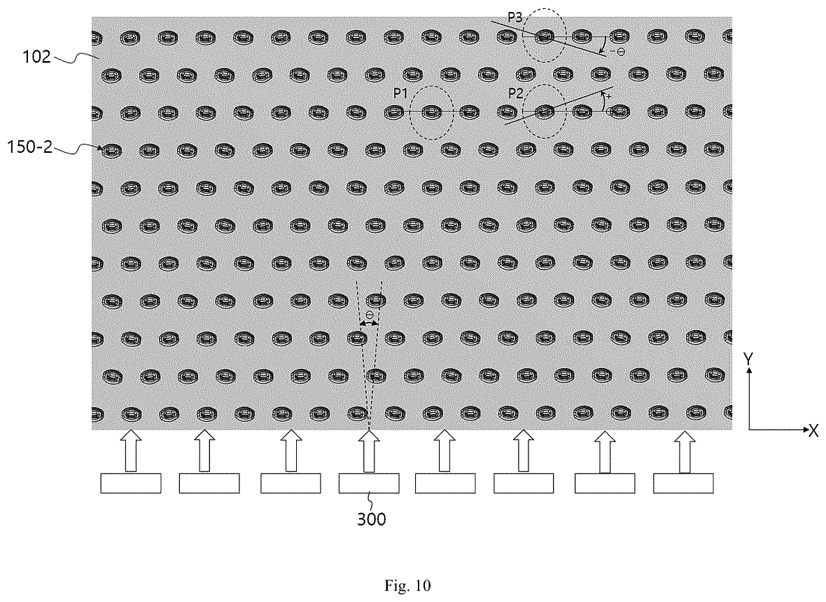

FIG. 12 is an enlarged view illustrating a portion of a bottom surface 102 of another light guide plate having the plurality of light emission patterns 150-2 in FIGS. 6A and 6B.

Each of the plurality of light emission patterns 150-2 of the light guide plate in FIG. 12 forms 0° with the reference axis X instead of being distorted at a specific angle.

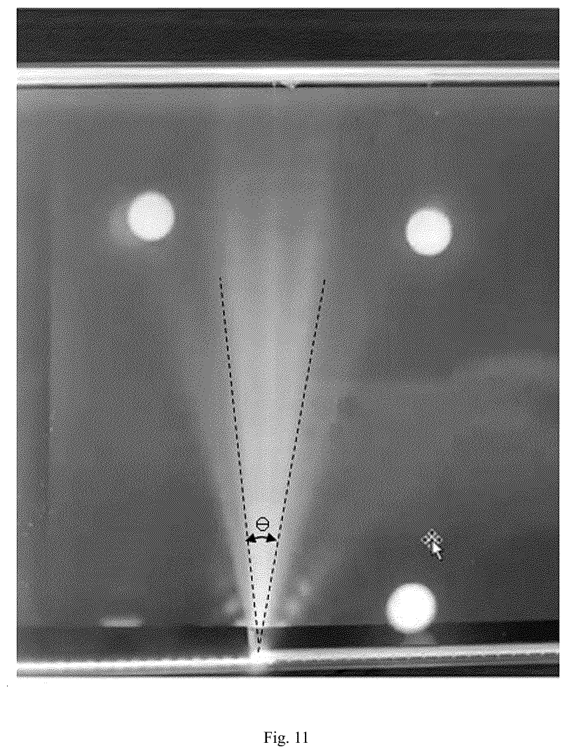

FIG. 13 is a substantial photograph showing light emitting surfaces of the light guide plates in FIGS. 10 and 12. A left photograph of FIG. 13 is a photograph showing the light emitting surface of the light guide plate in FIG. 10, and a right photograph of FIG. 13 is a photograph showing the light emitting surface of the light guide plate in FIG. 12.

First, referring to the right photograph of FIG. 13, it may be known that the searchlight phenomenon occurs in a portion S that is relatively close to the light source in case of the light guide plate in FIG. 12. On the other hand, referring to the left photograph of FIG. 13, it may be known that the searchlight phenomenon does not occur in case of the light guide plate in FIG. 10.

According to FIG. 13, in the light guide plate having a plurality of light emission patterns 150-2 in FIGS. 6A and 6B, when the plurality of light emission patterns 150-2 are distorted at angles within a predetermined range, the searchlight phenomenon may be relieved or removed.

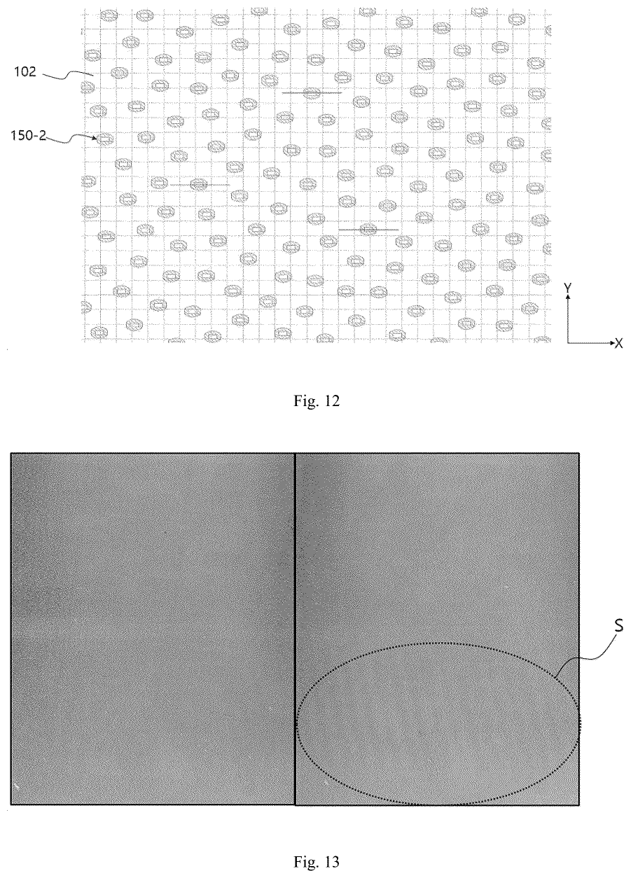

FIG. 14 is a SEM image showing a portion of the bottom surface of the light guide plate having the plurality of light emission patterns 150-2 in FIG. 10.

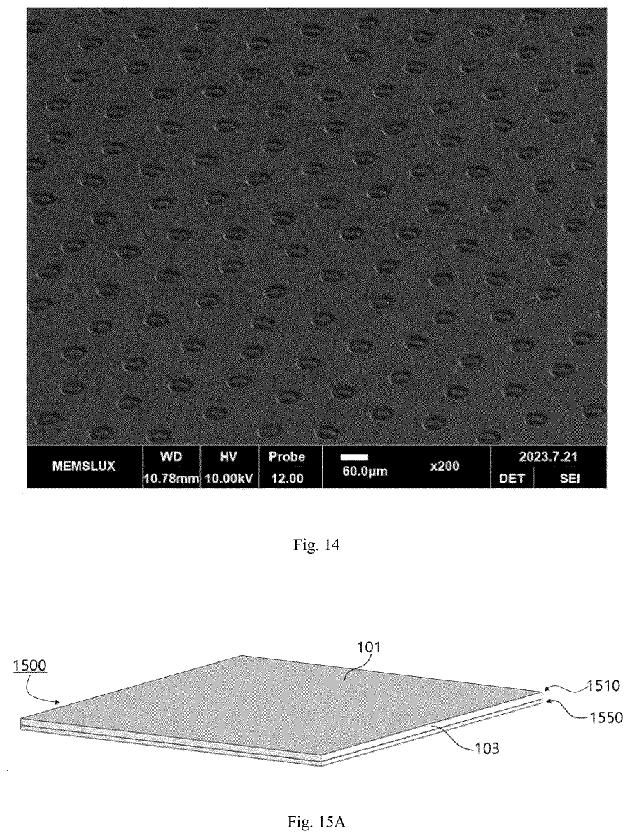

FIGS. 15A and 15B are views for explaining a light guide member 1500 according to another embodiment of the present invention.

Referring to FIGS. 15A and 15B, the light guide member 1500 according to another embodiment of the present invention includes a light guide plate 1510 having a top surface 101 through which light is emitted and a light emission pattern layer 1550 disposed below the light guide plate 1510 and having a plurality of light emission patterns 150 on a bottom surface 1552.

The light emission pattern is not disposed on a bottom surface (not shown) of the light guide plate 1510.

The light emission pattern layer 1550 may be attached to the bottom surface (not shown) of the light guide plate 1510.

The light emission pattern layer 1550 may be made of a resin material.

The light emission patterns 150 formed on the bottom surface 1552 of the light emission pattern layer 1550 may be the light emission patterns in FIGS. 3A to 9C, and have the plurality of light emission patterns 150 may have the arrangement structure of FIG. 10 or 12.

A difference between refractive indexes of the light guide plate 1510 and the light emission pattern layer 1550 may be 0.1 or less.

As described above, the light guide member 1500 shown in FIGS. 15A and 15B is obtained by combining the light emission pattern layer 1500 on which the plurality of light emission patterns 150 are formed with the light guide plate 1510. The light guide member 1500 may also exhibit the same or similar technical effects as the light guide plates according to the above-described various embodiments.

On the other hand, when compared with the light guide plates according to the above-described various embodiments, the light guide member 1500 in FIGS. 15A and 15B may have slightly low brightness due to a difference between refractive indexes of the light guide plate 1510 and the light emission pattern layer 1550, but have an advantage in terms of a material cost and a manufacturing process. Here, the relatively low brightness may be resolved as the difference between the refractive indexes of the light guide plate 1510 and the light emission pattern layer 1550 decreases.

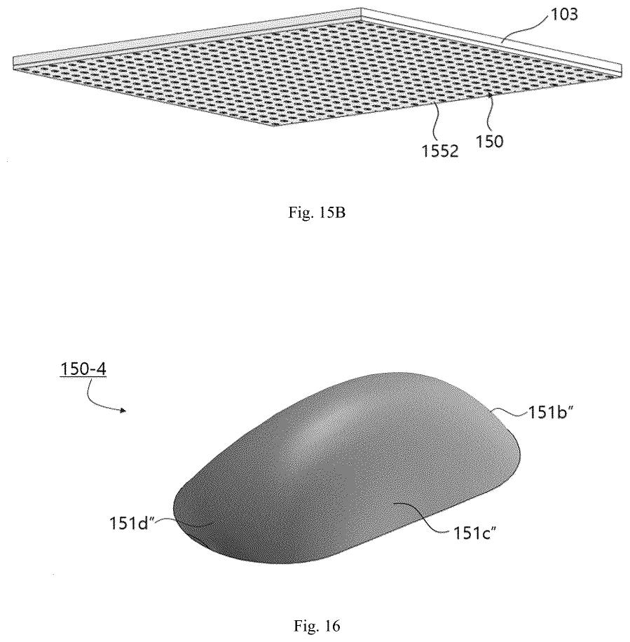

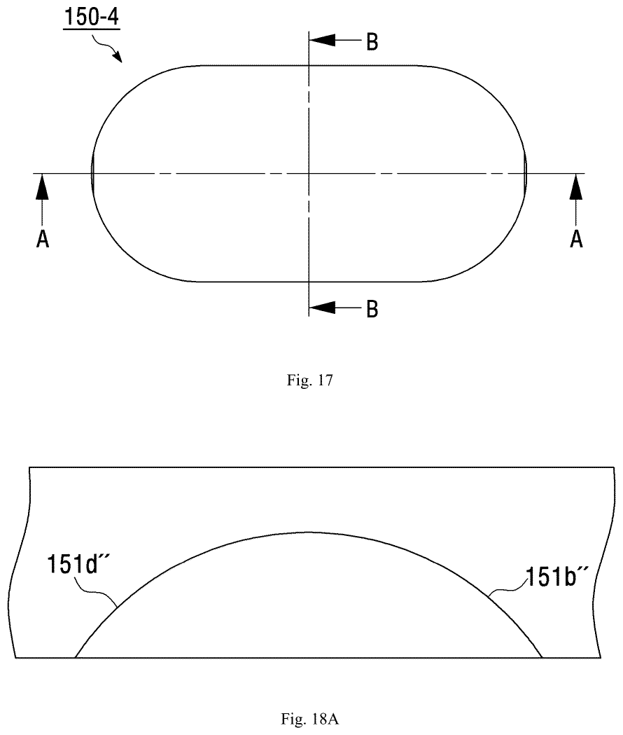

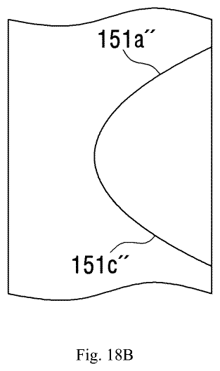

FIG. 16 is a perspective view illustrating another light emission pattern 150-4 that is applicable to FIGS. 2A, 2B, 15A, and 15B, FIG. 17 is a plan view illustrating the light emission pattern 150-4 in FIG. 16, and FIGS. 18A and 18B are cross-sectional views taken along lines A-A and B-B of the light emission pattern 150-4 in FIG. 17 and illustrating a portion of the light guide plate or the light emission pattern layer.

Referring to FIGS. 16 to 18B, the light emission pattern 150-4 according to another embodiment has an engraved shape.

The light emission pattern 150-4 may be used as the light guide plate in FIGS. 2A and 2B and as the light emission pattern 150 of the light emission pattern layer 1550 in FIGS. 15A and 15B.

The light emission pattern 150-4 may be an engraved pattern defined by a plurality of inclined surfaces 151a″, 151b″, 151c″, and 151d″ formed on the bottom surface of the light guide plate (or light emission pattern layer).

The plurality of inclined surfaces 151a″, 151b″, 151c″, and 151d″ include a first outer inclined surface 151a″, a second outer inclined surface 151b″, a third outer inclined surface 151c″, and a fourth outer inclined surface 151d″.

The first outer inclined surface 151a″ is disposed to face the third outer inclined surface 151c″.

One of the first outer inclined surface 151a″ and the third outer inclined surface 151c″ is disposed to face toward the light source.

One of the first outer inclined surface 151a″ and the third outer inclined surface 151c″ may be a curved surface protruding in an outward direction of the light emission pattern 150-4. One of the first outer inclined surface 151a″ and the third outer inclined surface 151c″ has a predetermined curvature.

As illustrated in FIG. 18B, each of the first outer inclined surface 151a″ and the third outer inclined surface 151c″ form an obtuse angle with the bottom surface of the light guide plate (or light emission pattern layer).

The second outer inclined surface 151b″ is disposed to face the fourth outer inclined surface 151d″.

The second outer inclined surface 151b″ and the fourth outer inclined surface 151d″ are disposed between the first outer inclined surface 151a″ and the third outer inclined surface 151c″.

One of the second outer inclined surface 151b″ and the fourth outer inclined surface 151d″ may be a curved surface protruding in an outward direction of the light emission pattern 150-4. The curved surface may have a predetermined curvature, and the curvature of one of the first outer inclined surface 151a″ and the third outer inclined surface 151c″ may be different.

Each of the second outer inclined surface 151b″ and the fourth outer inclined surface 151d″ may form an obtuse angle with the bottom surface of the light guide plate (or light emission pattern layer) as with the first outer inclined surface 151a″ and the third outer inclined surface 151c″ in FIG. 18B.

The first to fourth outer inclined surfaces 151a″, 151b″, 151c″, and 151d″ may be connected to each other to define an overall shape of the light emission pattern 150-4.

The light emission pattern 150-4 has an overall elliptical structure and is not defined by a flat inner top surface, unlike the light emission patterns 150-1 and 150-2 in FIGS. 5A and 5B or FIGS. 6A and 6B. That is, the light guide plate (or light emission pattern layer) does not have the flat inner top surface for defining the light emission pattern 150-4. Since the light guide plate (or light emission pattern layer) having the plurality of light emission patterns 150-4 does not have the flat inner top surface, the light guide plate has an advantage of reducing the high-angle light emission component caused by refraction when compared with the light emission patterns 150-1 and 150-2 in FIGS. 5A and 5B or FIGS. 6A and 6B.

The light guide plate, the light guide member, and the backlight unit including the same according to the embodiments of the present invention has the advantage of internalizing the functions of the diffuser sheet and the prism sheet of the typical flat backlight unit to eliminate the dependence on the optical sheet.

Also, the optical efficiency may be improved.

Also, the brightness may be improved.

Also, the searchlight phenomenon may be relieved or removed.

Also, the high-angle light emission component among the components of the light emitted from the top surface of the light guide plate may be minimized.

Although embodiments have been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A light guide plate that allows light received and guided through one side surface to be reflected and/or refracted by a bottom surface and to be emitted through a top surface,
wherein the bottom surface comprises a plurality of engraved light emission patterns,
wherein the bottom surface comprises a plurality of outer inclined surfaces that define the light emission patterns,
wherein the plurality of outer inclined surfaces comprises a first outer inclined surface, a second outer inclined surface, a third outer inclined surface, and a fourth outer inclined surface,
wherein the first and third outer inclined surfaces each protrude in an outward direction and are disposed to face each other, and one of the first and third outer inclined surfaces is disposed to face the one side surface, and
wherein the second and fourth outer inclined surfaces are disposed to face each other and disposed between the first and third outer inclined surfaces.

2. The light guide plate of claim 1, wherein the bottom surface further comprises a flat inner top surface and a protrusion that protrudes upward from the inner top surface, and
wherein the protrusion has a frustum shape having a width that gradually deceases in a direction in which the protrusion protrudes.

3. The light guide plate of claim 1, wherein each of the second and fourth outer inclined surfaces is recessed in an inward direction.

4. The light guide plate of claim 1, wherein a light distribution of the light guide plate is formed such that a light distribution in a horizontal direction parallel to the one side surface is relatively wider than that in a vertical direction perpendicular to the one side surface.

5. The light guide plate of claim 1, wherein a central angle of a fan using, as an arc, a line in contact with the bottom surface in the first or third outer inclined surface is an acute angle or an obtuse angle.

6. The light guide plate of claim 1, wherein the plurality of light emission patterns is arranged randomly on the bottom surface,
wherein each of the light emission patterns has a predetermined distortion within an angular range from −θ to +θ based on a reference axis parallel to the one side surface, and
wherein the θ corresponds to a divergence angle of light incident to one side surface of the light guide plate in the light guide plate.

7. The light guide plate of claim 6, wherein the number of light emission patterns for each distortion angle is uniform.

8. A backlight unit comprising:
the light guide plate of claim 1; and
a light source disposed on one side surface of the light guide plate.

9. A light guide member comprising:
a light guide plate configured to receive light through one side surface and emit light through a top surface; and
a light emission pattern layer disposed on a bottom surface of the light guide plate,
wherein the light emission pattern layer comprises a bottom surface having a plurality of engraved light emission patterns,
wherein the bottom surface of the light emission pattern layer comprises a plurality of outer inclined surfaces that define the light emission patterns,
wherein the plurality of outer inclined surfaces comprises a first outer inclined surface, a second outer inclined surface, a third outer inclined surface, and a fourth outer inclined surface,
wherein the first and third outer inclined surfaces each protrude in an outward direction to face each other, and one of the first and third outer inclined surfaces faces toward a surface parallel to the one side surface, and
wherein the second and fourth outer inclined surfaces are disposed to face each other and disposed between the first and third outer inclined surfaces.

10. The light guide member of claim 9, wherein the bottom surface of the light emission pattern further comprises a flat inner top surface and a protrusion that protrudes upward from the inner top surface, and
wherein the protrusion has a frustum shape having a width that gradually deceases in a direction in which the protrusion protrudes.

11. The light guide member of claim 9, wherein each of the second and fourth outer inclined surfaces is recessed in an inward direction.

12. The light guide member of claim 9, wherein a light distribution of the light guide plate is formed such that a light distribution in a horizontal direction parallel to the one side surface is relatively wider than that in a vertical direction perpendicular to the one side surface.

13. The light guide member of claim 9, wherein a central angle of a fan using, as an arc, a line in contact with the bottom surface of the light emission pattern layer in the first or third outer inclined surface is an acute angle or an obtuse angle.

14. The light guide member of claim 9, wherein the plurality of light emission patterns is arranged randomly on the bottom surface of the light emission pattern layer,
wherein each of the light emission patterns has a predetermined distortion within an angular range from −θ to +θ based on a reference axis parallel to the one side surface, and
wherein the θ corresponds to a divergence angle of light incident to one side surface of the light guide plate in the light guide plate.

15. The light guide member of claim 14, wherein the number of light emission patterns for each distortion angle is uniform.

16. A backlight unit comprising:
the light guide member of claim 9; and
a light source disposed on one side surface of the light guide plate.
